(19) United States
(12) Patent Application Publication
(10) Pub. No.: US 2019/0146145 A1
(43) Pub. Date: May 16, 2019

(54) ULTRA-NARROW BEZEL BACKLIGHT MODULE AND DISPLAY DEVICE

(71) Applicant: Wuhan China Star Optoelectronics Technology Co., Ltd., Wuhan, Hubei (CN)

(72) Inventor: Hua GU, Wuhan, Hubei (CN)

(21) Appl. No.: 15/742,793

(22) PCT Filed: Nov. 21, 2017
(86) PCT No.: PCT/CN2017/112063

§ 371 Date: Jan. 8, 2018

(30) Foreign Application Priority Data
Nov. 15, 2017 (CN) 201711130710.6

(51) Int. Cl. F21V 8/00

(52) U.S. Cl. CPC G02B 6/0088; G02B 6/009; G02B 6/0053; G02B 6/0055

(57) ABSTRACT

An ultra-narrow bezel backlight module is provided in the present application, including a light guide plate, a light source, a light-shielding layer and an optical film set, wherein the light source is an edge type light source, and is disposed at a light incident end of the light guide plate, the optical film set is disposed on a light emitting surface of an upper surface of the light guide plate, the light-shielding layer is adhered to an edge and an end surface of an upper surface of the optical film set and is wrapped to an end surfaces of each non-light incident ends and an edge of a lower surface of the light guide plate. A display panel is also provided in the present application.

### RELATED APPLICATIONS

The present application is a National Phase of International Application Number PCT/CN2017/112063, filed Nov. 21, 2017, and claims the priority of China Application No. 201711130710.6, filed Nov. 15, 2017.

### BACKGROUND OF THE INVENTION

### 1. Field of the Invention

The disclosure relates to a display technical field, and more particularly to an ultra-narrow bezel backlight module and a display device.

### 2. The Related Arts

With the wide application of the liquid crystal display device in various fields, people have put forward higher requirements for thinning of the liquid crystal display device and the and narrowing of the bezel, requiring the thickness of the liquid crystal display module to be as thin as possible, and the bezel as narrow as possible.

The existing small size backlight module generally adopts the glue frame for the support and fixation of the material. To design the ultra-narrow bezel, the glue frame is located at the periphery of the optical structure such as the light guide plate and the optical film set, and then a light shielding glue is used to block the gap between the optical film set and the glue frame, under the frame with the glue frame as the main body, the width of the left and right bezels of the backlight module is the minimum gluing width of the light shielding glue on the surface of the optical film set, the minimum gap of the optical film set to the inner wall of the glue frame and the thickness of the glue frame, in the above parameters cannot be further reduced by the limitation of the process, that is to achieve the narrowest state of such design.

### SUMMARY

In view of the deficiencies of the conventional technology, the present application provides an ultra-narrow bezel backlight module and a display device.

In order to achieve the above object, the present application adopts the following technical solutions:

An ultra-narrow bezel backlight module, includes a light guide plate, a light source, a light-shielding layer and an optical film set, wherein the light source is an edge type light source, and is disposed at a light incident end of the light guide plate, the optical film set is disposed on a light emitting surface of an upper surface of the light guide plate, the light-shielding layer is adhered to an edge and an end surface of an upper surface of the optical film set and is wrapped to an end surfaces of each non-light incident ends and an edge of a lower surface of the light guide plate.

As one of the embodiments, the ultra-narrow bezel backlight module further including a reflective sheet, wherein the reflective sheet is adhered to the lower surface of the light guide plate, and the light-shielding layer is adhered to an edge of the reflective sheet.

As one of the embodiments, a through hole is disposed in an edge of the optical film set, a protrusion is disposed at an inner surface of the light-shielding layer close to an end portion of the optical film set, the protrusion is inserted into the through hole.

As one of the embodiments, end faces of the light guide plate, the optical film set, and the non-light incident end of the reflective sheet are also flush with each other.

As one of the embodiments, an inner surface of the light-shielding layer is a reflective layer.

As one of the embodiments, a portion of the light-shielding layer adhered to the upper surface of the optical film set is a double-sided adhesive layer.

As one of the embodiments, the optical film set includes a plurality of laminated stacked prism sheets, an edge of an upper surface of an uppermost prism sheet is a flat surface, the light-shielding layer is adhered to the edge of the uppermost prism sheet.

As one of the embodiments, the ultra-narrow bezel backlight module further including a U-shaped frame body, wherein the frame body is disposed in the light incident end of the light guide plate, the light source is enclosed in a space surrounded by the frame body and the light guide plate.

As one of the embodiments, the light source is fixed in an inner surface of the frame body.

Another object of the present application is to provide a display device including a display panel and the ultra-narrow bezel backlight module, the display panel is disposed above the optical film set.

The bezel width of a non-light incident side of the backlight module of the present application is merely the width of the light-shielding layer at the edge of the surface of the optical film set, and thus can be fabricated very narrow, thus achieving the ultra-narrow bezel design of the backlight module, and enhancing the product competitiveness in the market.

### BRIEF DESCRIPTION OF THE DRAWINGS

FIG. 1 is a front-side view schematic diagram of a backlight module according to an embodiment of the present application;

FIG. 2 is a backside view schematic diagram of a backlight module according to an embodiment of the present application;

FIG. 3a is a partial structure schematic diagram of a non-light incident end of a backlight module according to an embodiment of the present application;

FIG. 3b is a partial structure schematic diagram of a non-light incident end of another backlight module according to an embodiment of the present application;

FIG. 3c is a partial structure schematic diagram of a non-light incident end of still another backlight module according to an embodiment of the present application;

FIG. 4 is a partial structure schematic diagram of a light incident end of a backlight module according to an embodiment of the present application; and

FIG. 5 is a partial structure schematic diagram of a light incident end of another backlight module according to an embodiment of the present application.

### DETAILED DESCRIPTION OF THE PREFERRED EMBODIMENTS

In order to make the objectives, technical solutions and advantages of the present application more comprehensible, the present application is further described in detail below with reference to the accompanying drawings and embodiments. It should be understood that the specific embodiments described herein are merely used to explain the present application, and are not intended to limit the present application.

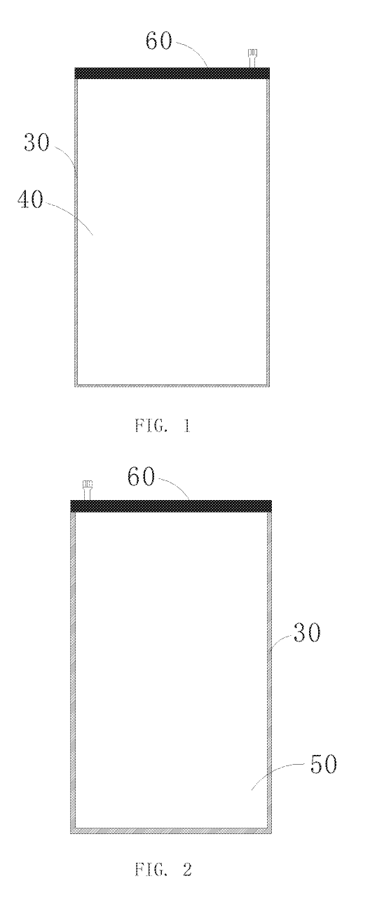

Referring to FIGS. 1 to 3a, an ultra-narrow bezel backlight module according to an embodiment of the present application mainly includes: a light guide plate 10, a light source 20, a light-shielding layer 30 and an optical film set 40. The light source 20 is an edge type LED light source, and is disposed at the light incident end of the light guide plate 10, the optical film set 40 is disposed on upper surface of the light guide plate 10 that is the side of the light emitting surface, the light-shielding layer 30 is adhered to the edge and the end surface of the upper surface of the optical film set 40, and wraps the end surfaces of each non-light incident ends and edge of the lower surface of the light guide plate 10.

The light-shielding layer 30 is also wrapped to the edges of the light guide plate 10 and the optical film set 40, to prevent light from leaking from the side, and the structure of the backlight module can be integrated as one body, so that the structure such as the glue frame and the front frame can be omitted, so that the bezel width of the non-light incident side of the backlight module is merely the width of the light-shielding layer at the edge of the surface of the optical film set, the backlight module can be fabricated very narrow, achieving the ultra-narrow bezel design of the backlight module. As shown in FIG. 1 and FIG. 2, the edge of the upper surface of the optical film set 40 is wrapped by the light-shielding layer 30, only a very narrow part is required, and the light-shielding layer 30 on the bottom surface of the backlight module can be fabricated relatively wider, to ensure better adhesion effect, without affecting the backlight effect.

A reflective sheet 50 is adhered to the lower surface of the light guide plate 10, to reflect the light incident thereon onto the light guide plate 10 for secondary usage. Scattering particles can also be evenly arranged on the lower surface of the light guide plate 10, after the light in the light guide plate 10 is dispersed, and emitting from the light emitting side of the upper portion. The periphery four edges of the reflective sheet 50 are flush with the light guide plate 10, the lower end of the light-shielding layer 30 extends to adhere to the end face and the edge of the reflective sheet 50.

Here, the light-shielding layer 30 is a light shielding tape. The end surface of the light guide plate 10 and the non-light incident end of the optical film set 40 are also flush with each other to facilitate the wrapping and attaching of the light-shielding layer 30. In addition, the inner surface of the light-shielding layer 30 can also be made as a reflective layer, the light leaking from the light guide plate 10 and the edge of the optical film set 40 can be reflected back.

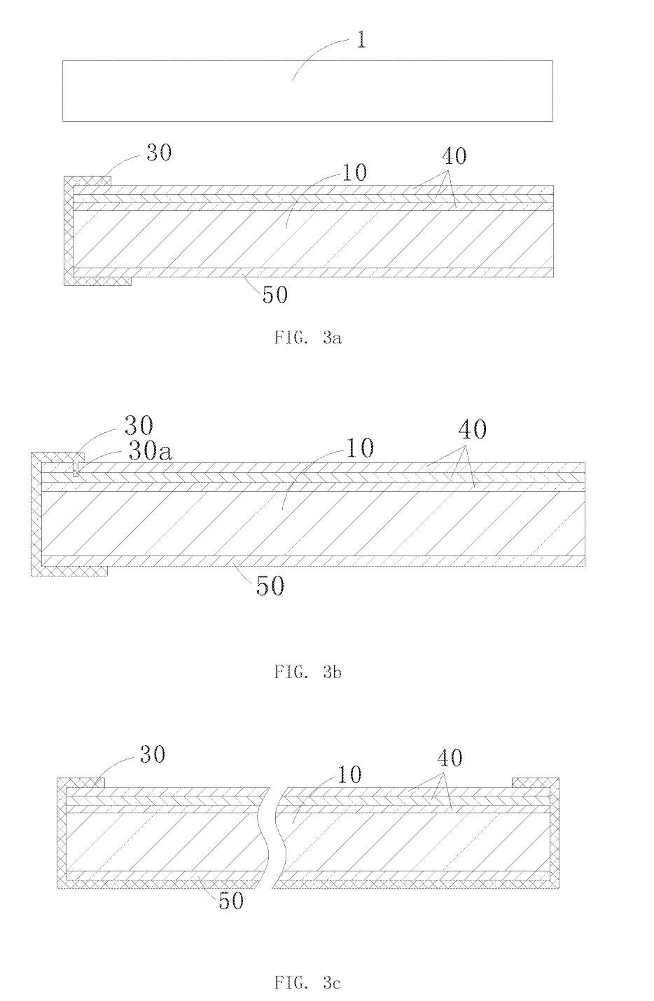

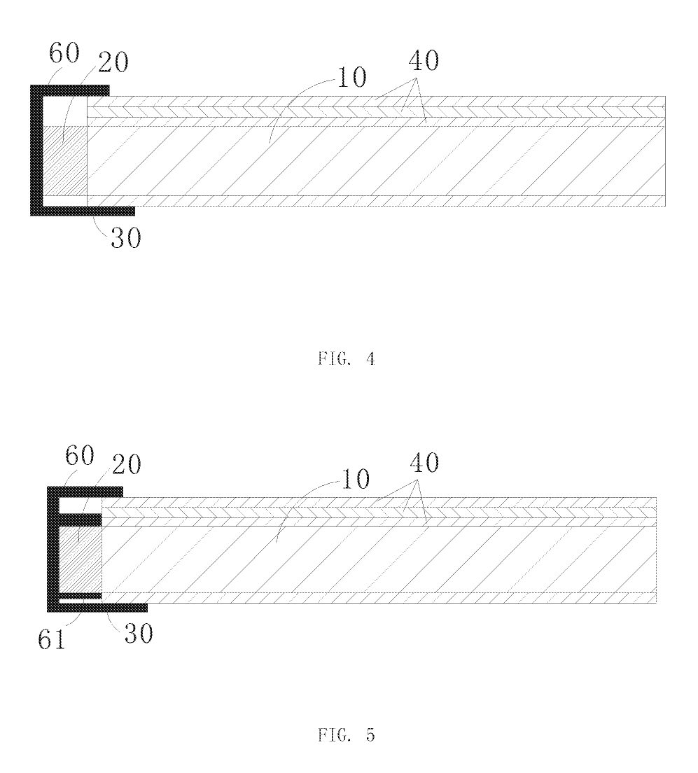

As shown in FIG. 3a, the display device includes a display panel 1 and the backlight module. The display panel 1 is disposed above the optical film set 40. The portion of the light-shielding layer 30 adhered to the upper surface of the optical film set 40 is a double-sided adhesive layer, the display panel 1 is adhered to the backlight module through the double-sided adhesive layer on the upper surface of the light-shielding layer 30.

In one of the embodiments, the optical film set 40 includes a plurality of laminated stacked prism sheets, the edge of the upper surface of the uppermost prism sheet is a flat surface, the light-shielding layer 30 is adhered to the flat surface of the edge of the uppermost prism sheet, thereby ensuring a good adhesion effect. In other embodiments, a prism surface of the uppermost prism sheet may also face the light guide plate 10, and the upper surface of the prism surface is arranged as the flat surface.

As shown in FIG. 3b, an inner surface of the light-shielding layer 30 close to the end portion of the optical film set 40 may further be provided with a protrusion 30a. The protrusion 30a is a convex column or a convex block. By disposing a through hole in the edge of the optical film set 40, the protrusion 30a is inserted into the corresponding through hole. When the display panel 1 is adhered to and pressed against the portion of the light-shielding layer 30, the anti-separation effect of the upper portion of the light-shielding layer 30 can be improved, so as to improve the fixing reliability of the light-shielding layer 30 and the optical film set 40.

As shown in FIG. 3c, the light-shielding layer 30 at the bottom of the backlight module can be extended to completely wrap the reflective sheet 50. A layer of the light-shielding layer 30 is adhered to the entire bottom surface and the end surface of the reflective sheet 50, each of the non-light incident end surfaces of the light guide plate 10, the end surfaces and the edge of the upper surface of the optical film set 40, to improve the reliability of the overall structure of the backlight module.

As shown in FIG. 4, in the light incident end of the backlight module, the present embodiment further includes a U-shaped frame body 60, the frame body 60 is configured as a lamp shade, and is disposed in the light incident end of the light guide plate 10. The light source 20 is enclosed in a space surrounded by the frame body 60 and the light guide plate 10. The upper end and the lower end of the frame body 60 respectively clamp the optical film set 40 and the light guide plate 10, and closely contact the edges of the optical film set 40 and the light guide plate 10. The adhesion fixation to the optical film set 40 and the light guide plate 10 can also be achieved by a colloid or the like. The material of the frame body 60 can be selected from a thin metal sheet or a plastic with good elasticity. By utilizing the elasticity of the frame body 60 to achieve a certain clamping effect, a pre-positioning can be achieved, and then fixed at the corresponding position by adhesion or the like methods.

On the one hand, the frame body 60 can serve as the lamp shade to protect the light source 20 and the light incident end of the backlight module. On the other hand, the light source 20 can also be fixed on the inner surface of the frame body 60. As shown in FIG. 5, the frame body 60 is provided with a limiting plate 61 protruding toward the inner surface of the light guide plate 10. The limiting plate 61 is disposed as a ring shape, so that the light source 20 can be mounted therein. The end face of the limiting plate 61 abuts on the light guide plate 10, the reflective sheet 50 or the end face of the optical film set 40, to ensures the light coupling distance of the light source 20 on the one hand, and in the other hand, it also enables the upper and lower ends of the frame 60 to maintain good contact state with the optical film set 40 and the reflective sheet 50 without being skewed.

The bezel width of the non-light incident side of the backlight module of the present application is merely the width of the light-shielding layer at the edge of the surface of the optical film set, and thus can be fabricated very narrow, thus achieving the ultra-narrow bezel design of the backlight module, and enhancing the product competitiveness in the market. In addition, the lamp shade of the U-shaped frame structure is located at the light incident end of the backlight module, and clamping the edges of the optical film set and the light guide plate, eliminating the glue frame and the slot structure for holding the light source in the glum frame, the light incident side of the backlight module only needs to preset a holding length of the lamp shade and the bezel width of the light incident side of the backlight module can also be narrowed.

The foregoing contents are detailed description of the disclosure in conjunction with specific preferred embodiments and concrete embodiments of the disclosure are not limited to these descriptions. For the person skilled in the art of the disclosure, without departing from the concept of the disclosure, simple deductions or substitutions can be made and should be included in the protection scope of the application.

What is claimed is:

1. An ultra-narrow bezel backlight module, comprising: a light guide plate, a light source, a light-shielding layer and an optical film set, wherein the light source is an edge type light source, and is disposed at a light incident end of the light guide plate, the optical film set is disposed on a light emitting surface of an upper surface of the light guide plate, the light-shielding layer is adhered to an edge and an end surface of an upper surface of the optical film set and is wrapped to an end surfaces of each non-light incident ends and an edge of a lower surface of the light guide plate.

2. The ultra-narrow bezel backlight module according to claim 1, further comprising a reflective sheet, wherein the reflective sheet is adhered to the lower surface of the light guide plate, and the light-shielding layer is adhered to an edge of the reflective sheet.

3. The ultra-narrow bezel backlight module according to claim 2, wherein a through hole is disposed in an edge of the optical film set, a protrusion is disposed at an inner surface of the light-shielding layer close to an end portion of the optical film set, the protrusion is inserted into the through hole.

4. The ultra-narrow bezel backlight module according to claim 2, wherein end faces of the light guide plate, the optical film set and the non-light incident end of the reflective sheet are also flush with each other.

5. The ultra-narrow bezel backlight module according to claim 2, wherein an inner surface of the light-shielding layer is a reflective layer.

6. The ultra-narrow bezel backlight module according to claim 2, wherein a portion of the light-shielding layer adhered to the upper surface of the optical film set is a double-sided adhesive layer.

7. The ultra-narrow bezel backlight module according to claim 1, wherein the optical film set comprises a plurality of laminated stacked prism sheets, an edge of an upper surface of an uppermost prism sheet is a flat surface, the light-shielding layer is adhered to the edge of the uppermost prism sheet.

8. The ultra-narrow bezel backlight module according to claim 1, further comprising a U-shaped frame body, wherein the frame body is disposed in the light incident end of the light guide plate, the light source is enclosed in a space surrounded by the frame body and the light guide plate.

9. The ultra-narrow bezel backlight module according to claim 8, wherein the light source is fixed in an inner surface of the frame body.

10. The ultra-narrow bezel backlight module according to claim 3, further comprising a U-shaped frame body, wherein the frame body is disposed in the light incident end of the light guide plate, the light source is enclosed in a space surrounded by the frame body and the light guide plate.

11. The ultra-narrow bezel backlight module according to claim 10, wherein the light source is fixed in an inner surface of the frame body.

12. The ultra-narrow bezel backlight module according to claim 4, further comprising a U-shaped frame body, wherein the frame body is disposed at the light incident end of the light guide plate, the light source is enclosed in a space surrounded by the frame body and the light guide plate.

13. The ultra-narrow bezel backlight module according to claim 12, wherein the light source is fixed in an inner surface of the frame body.

14. The ultra-narrow bezel backlight module according to claim 7, further comprising a U-shaped frame body, wherein the frame body is disposed at the light incident end of the light guide plate, the light source is enclosed in a space surrounded by the frame body and the light guide plate.

15. The ultra-narrow bezel backlight module according to claim 14, wherein the light source is fixed in an inner surface of the frame body.

16. A display device comprising a display panel and an ultra-narrow bezel backlight module, wherein the ultra-narrow bezel backlight module comprises a light guide plate, a light source, a light-shielding layer and an optical film set, wherein the light source is an edge type light source, and is disposed at a light incident end of the light guide plate, the optical film set is disposed on a light emitting surface of an upper surface of the light guide plate, the light-shielding layer is adhered to an edge and an end surface of an upper surface of the optical film set and is wrapped to an end surfaces of each non-light incident ends and an edge of a lower surface of the light guide plate.

17. The display device according to claim 16, wherein the ultra-narrow bezel backlight module further comprises a reflective sheet, wherein the reflective sheet is adhered to the lower surface of the light guide plate, and the light-shielding layer is adhered to an edge of the reflective sheet.

18. The display device according to claim 17, wherein a through hole is disposed in an edge of the optical film set, a protrusion is disposed at an inner surface of the light-shielding layer close to an end portion of the optical film set, the protrusion is inserted into the through hole.

19. The display device according to claim 17, wherein the optical film set comprises a plurality of laminated stacked prism sheets, an edge of an upper surface of an uppermost prism sheet is a flat surface, the light-shielding layer is adhered to the edge of the uppermost prism sheet.

20. The display device according to claim 19, wherein the ultra-narrow bezel backlight module further comprises a U-shaped frame body, the frame body is disposed at the light incident end of the light guide plate, the light source is enclosed in a space surrounded by the frame body and the light guide plate, the light source is fixed in an inner surface of the frame body.
